(19) United States
(12) Patent Application Publication
(10) Pub. No.: US 2026/0368751 A1
(43) Pub. Date: Nov. 19, 2026

(54) INTELLIGENT INTERACTION METHOD AND SYSTEM, STORAGE MEDIUM, AND DEVICE

(71) Applicant: Alipay (Hangzhou) Digital Service Technology Co., Ltd., Hangzhou (CN)

(72) Inventors: Han YUE, Hangzhou (CN); Chuang SHENG, Hangzhou (CN)

(21) Appl. No.: 19/639,006

(22) Filed: Apr. 3, 2026

(30) Foreign Application Priority Data
Apr. 3, 2025 (CN) 202510420985.1

(51) Int. Cl. G06Q 30/015

(52) U.S. Cl. CPC G06Q 30/015

(57) ABSTRACT

Implementations of this specification provide an intelligent customer service interaction method and system, a storage medium, and a device. In the above method, an interaction page is rendered on a user terminal in response to a user accessing an intelligent customer service interaction system, the interaction page including a digital human; and an interaction system obtains user interaction content, makes decision recommendation on the user interaction content by using an interaction model and/or a predetermined policy, to obtain recommended content, and renders and displays the recommended content on an interaction page, for the digital human to explain and describe the recommended content during display.

### TECHNICAL FIELD

The present specification relates to computer technologies, and in particular, to an intelligent interaction method and system, a storage medium, and a device.

### BACKGROUND

With the increasing demands for efficiency and quality in the human-machine interaction industry, some human machine interaction require human representatives to possess strong professional knowledge to interfere with the human machine interaction. Such human machine interaction systems typically function based on manual interference of human representatives or predefined answer templates.

### SUMMARY

Implementations of this specification provide an intelligent interaction method and system, a storage medium, and a device. By using the intelligent interaction method provided in the implementations of this specification, a pre-trained interaction model can be used to understand user interaction content, make decision recommendation based on the user interaction content, and output recommended content used to interact with a user. The interaction model understands and stores a large amount of professional information, which can provide the user with a professional customer service. Furthermore, a digital human technology is used to explain and describe the recommended content output by the interaction model, providing the user with an enhanced experience.

An implementation of this specification provides an intelligent interaction method, including: rendering an interaction page on a user terminal in response to a user accessing an intelligent interaction system, the interaction page including a digital human; obtaining user interaction content, and making decision recommendation on the user interaction content by using an interaction model and/or a predetermined policy, to obtain recommended content; and rendering and displaying the recommended content on the interaction page, for the digital human to explain and describe the recommended content.

Further, in some implementations, the interaction page includes a recommended service option; and the rendering the interaction page on the user terminal in response to the user accessing the intelligent interaction system includes: obtaining user historical data in response to the user accessing the intelligent interaction system, the user historical data including interactive conduct data and/or historical interaction data; determining at least one recommended service based on the user historical data; and rendering the interaction page on the user terminal based on the at least one recommended service, to display the recommended service option on the interaction page.

Further, in some implementations, the method further includes: generating an interaction ID corresponding to the current interaction in response to the user accessing the intelligent interaction system.

Further, in some implementations, after the obtaining the user historical data, the method further includes: determining, based on the historical interaction data, whether the user has an incomplete historical interaction dialogue; and in response to that it is determined that the user has an incomplete historical interaction dialogue, searching for a corresponding historical interaction record based on a historical interaction ID corresponding to the historical interaction dialogue, and restoring the historical interaction dialogue based on the historical interaction record and rendering the interaction page; or in response to that it is determined that the user does not have an incomplete historical interaction dialogue, performing the step of determining the at least one recommended service based on the user historical data.

Further, in some implementations, the making decision recommendation on the user interaction content by using the interaction model and/or the predetermined policy, to obtain the recommended content includes: obtaining user historical data, the user historical data including interactive conduct data and/or historical interaction data; and making decision recommendation based on the user historical data and the user interaction content by using the interaction model and/or the predetermined policy, to obtain the recommended content.

Further, in some implementations, the recommended content includes at least one of a recommended interactive text and a recommended interactive component, and the recommended interactive component is configured to provide a corresponding interactive conduct for the user.

Further, in some implementations, the making decision recommendation based on the user historical data and the user interaction content by using the interaction model and/or the predetermined policy, to obtain the recommended content includes: generating the recommended interactive text based on the user historical data and the user interaction content by using the interaction model and/or the predetermined policy, and interacting with the user based on the recommended interactive text, to obtain new user interaction content; and making decision recommendation based on the user historical data, the user interaction content, and the new user interaction content by using the interaction model and/or the predetermined policy, to obtain the recommended interactive component.

Further, in some implementations, the recommended interactive component includes but is not limited to an identity verification component, a penalty component, a reporting component, a limit removal component, a trial component, and a security education component.

An implementation of this specification further provides an intelligent interaction system, including: a page rendering module, configured to render an interaction page on a user terminal in response to a user accessing an intelligent interaction system, the interaction page including a digital human; a content recommendation module, configured to obtain user interaction content, and make decision recommendation on the user interaction content by using an interaction model and/or a predetermined policy, to obtain recommended content; and a content interaction module, configured to render and display the recommended content on the interaction page, for the digital human to explain and describe the recommended content.

An implementation of this specification further provides a computer program product. The computer program product stores at least one instruction, and the at least one instruction is suitable for a processor to load and perform the steps of the above method.

An implementation of this specification further provides a computer storage medium. The computer storage medium stores a computer program, and the computer program is suitable for a processor to load and perform the steps of the above method.

An implementation of this specification further provides an electronic device, including a processor and a memory. The memory stores a computer program, and the computer program is suitable for the processor to load and perform the steps of the above methods.

In the implementations of this specification, in the above intelligent interaction method, the interaction page is rendered on the user terminal in response to the user accessing the intelligent interaction system, the interaction page including the digital human; the user interaction content is obtained, and decision recommendation is made on the user interaction content by using the interaction model and/or the predetermined policy, to obtain the recommended content; and the recommended content is rendered and displayed on the interaction page, for the digital human to explain and describe the recommended content. A pre-trained interaction model is used to understand user interaction content, make decision recommendation based on the user interaction content, and output recommended content used to interact with the user. The interaction model understands and stores a large amount of professional content base information, which can provide the user with a professional content recommendations. Furthermore, a digital human technology is used to explain and describe the recommended content output by the interaction model, providing the user with an enhanced experience.

### BRIEF DESCRIPTION OF DRAWINGS

FIG. 1 is a schematic flowchart illustrating an intelligent interaction method according to an implementation of this specification;

FIG. 2 is a schematic flowchart illustrating an intelligent interaction method according to an implementation of this specification;

FIG. 3 is a schematic flowchart illustrating an intelligent interaction method according to an implementation of this specification;

FIG. 4 is a schematic structural diagram illustrating an intelligent interaction system according to an implementation of this specification; and

FIG. 5 is a schematic structural diagram illustrating an electronic device according to an implementation of this specification.

### DESCRIPTION OF IMPLEMENTATIONS

To make the objectives, technical solutions, and advantages of this specification clearer, the following clearly and comprehensively describes the technical solutions in this specification with reference to specific implementations of this specification and corresponding accompanying drawings. Clearly, the described implementations are merely some rather than all of the implementations of this specification. Based on the implementations of this specification, all other implementations obtained by a person of ordinary skill in the art without creative efforts fall within the protection scope of this specification.

With the increasing demands for efficiency and quality in the content sharing or streaming industry, some human machine systems typically provide services based on human interference or predefined answer templates.

However, human representatives often have varying skill levels. Those lacking strong professional knowledge are frequently unable to satisfy users' genuine needs, while predefined answer templates lack flexibility and personalized interaction capabilities, often failing to adapt to complex user queries and thus unable to satisfy the needs of modern consumers and businesses.

Based on this, implementations of this specification provide a human machine intelligent interaction (referred to herein as “intelligent interaction”) method and a classification model optimization method. By using the intelligent interaction method, a pre-trained interaction model is used to understand user interaction content, make decision recommendation based on the user interaction content, and output recommended content used to interact with a user. The interaction model understands and stores a large amount of professional information, which can provide the user with a professional customer service. Furthermore, a digital human technology is used to explain and describe the recommended content output by the interaction model, providing the user with an enhanced experience.

FIG. 1 is a schematic flowchart illustrating an intelligent interaction method according to an implementation of this specification. In some implementations of this specification, the intelligent interaction method is applied to an intelligent interaction system or an electronic device configured with an intelligent interaction system. The following describes the process shown in FIG. 1 in detail. The intelligent interaction method can specifically include the following steps:
S102: Render an interaction page on a user terminal in response to a user accessing an intelligent interaction system, the interaction page including a digital human.

The intelligent interaction system can be a system disposed in a service platform, an APP, and a transaction platform, and is configured to answer various questions encountered by a user in a service and transaction processing process.

In one or more implementations of some implementations of this specification, the user can access the intelligent interaction system through a system interface preset on the user terminal. When detecting that the user accesses the intelligent interaction system, the system renders the interaction page including the digital human on the user terminal.
S104: Obtain user interaction content, and make decision recommendation on the user interaction content by using an interaction model and/or a predetermined policy, to obtain recommended content.

In some implementations of this specification, after accessing the intelligent interaction system, the user can access interaction content on the interaction page in a text or voice input manner. The intelligent interaction system obtains the interaction content accessed by the user, and then makes decision recommendation based on the user interaction content by using the pre-trained interaction model and/or the predetermined policy, to obtain the recommended content.

In some implementations, the making decision recommendation based on the interaction content of the user by using the pre-trained interaction model and/or the predetermined policy, to obtain the recommended content can be specifically: first performing normalized feature processing on the obtained user interaction content to obtain a processed interaction content feature, and accessing the processed interaction content feature into the pre-trained interaction model or the predetermined policy to obtain the recommended content output by the interaction model or the predetermined policy.
S106: Render and display the recommended content on the interaction page, for the digital human to explain and describe the recommended content.

In some implementations of this specification, after the recommended content is obtained, the recommended content is rendered and displayed on the interaction page, for the digital human to explain and describe the recommended content.

In some implementations, the digital human can explain and describe the recommended content with reference to a body movement and a facial expression.

In some implementations of this specification, in the above intelligent method, the interaction page is rendered on the user terminal in response to the user accessing the intelligent interaction system, the interaction page including the digital human; the user interaction content is obtained, and decision recommendation is made on the user interaction content by using the interaction model and/or the predetermined policy, to obtain the recommended content; and the recommended content is rendered and displayed on the interaction page, for the digital human to explain and describe the recommended content. A pre-trained interaction model is used to understand user interaction content, make decision recommendation based on the user interaction content, and output recommended content used to interact with the user. The interaction model understands and stores a large amount of professional information, which can provide the user with a professional customer service. Furthermore, a digital human technology is used to explain and describe the recommended content output by the interaction model, providing the user with an enhanced experience.

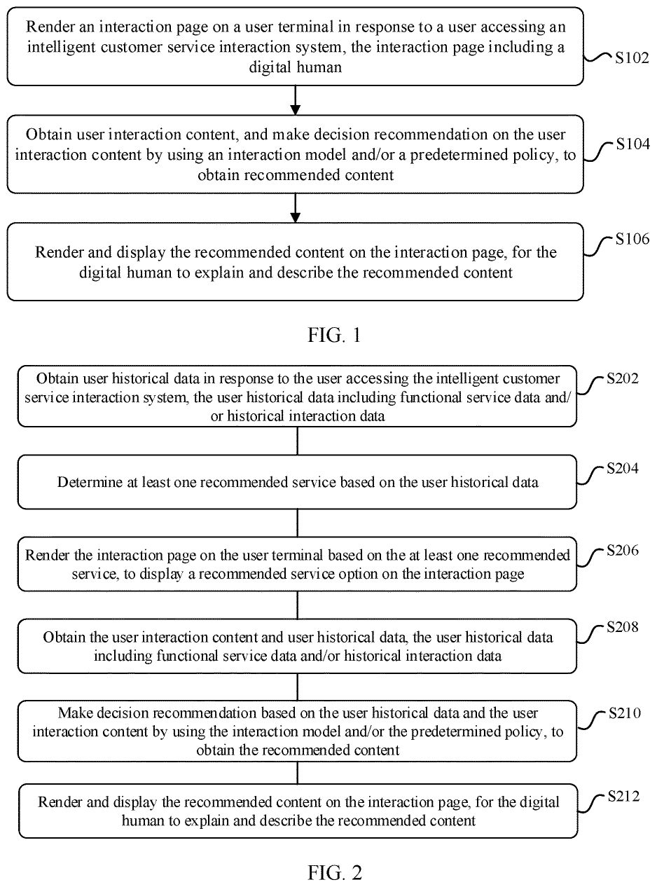

In an implementation, FIG. 2 is a schematic flowchart illustrating an intelligent interaction method according to an implementation of this specification. As shown in FIG. 2, the following steps are included:
S202: Obtain user historical data in response to the user accessing the intelligent interaction system, the user historical data including interactive conduct data and/or historical interaction data;

In some implementations of this specification, after the user accesses the intelligent interaction system, the interaction system obtains a user identifier, and then queries and obtains the user historical data of the user within a latest period of time in a data center based on the user identifier. The user historical data includes the interactive conduct data and the historical interaction data.
S204: Determine at least one recommended service based on the user historical data.

In some implementations of this specification, after obtaining the user historical data, the interaction system determines the at least one recommended service based on the user historical data.
S206: Render the interaction page on the user terminal based on the at least one recommended service, to display a recommended service option on the interaction page.

In some implementations of this specification, after obtaining the user historical data, the interaction system determines the at least one recommended service based on the user historical data. Then, the interaction system displays the determined recommended service on the interaction page as an interaction guide. For example, if a service expected by the user is one of the determined at least one recommended service, the user can directly access a corresponding service process by displaying a recommended service option on the interaction page, thereby reducing an interaction process and improving user experience. If the service expected by the user is not the determined recommended service, the interaction system continues to perform an interaction process in step S208.
S208: Obtain the user interaction content and user historical data, the user historical data including interactive conduct data and/or historical interaction data.
S210: Make decision recommendation based on the user historical data and the user interaction content by using the interaction model and/or the predetermined policy, to obtain the recommended content.

In some implementations of this specification, after accessing the intelligent interaction system, the user can access interaction content on the interaction page in a text or voice input manner. The intelligent interaction system obtains the interaction content accessed by the user and queries and obtains the user historical data of the user within a latest period of time in a data center based on the user identifier, where the user historical data includes the interactive conduct data and the historical interaction data, and then makes decision recommendation based on the user interaction content and the user historical data by using the pre-trained interaction model and/or the predetermined policy, to obtain the recommended content.

It can be understood that, in an interaction process, the intelligent interaction system can make content recommendation based on a combination of the user interaction content and the user historical data that are accessed in real time by the user, which can improve accuracy of content recommendation, and ensure that recommended content more accurately satisfies a user intention, thereby improving user interaction experience.
S212: Render and display the recommended content on the interaction page, for the digital human to explain and describe the recommended content.

In some implementations of this specification, after the recommended content is obtained, the recommended content is rendered and displayed on the interaction page, for the digital human to explain and describe the recommended content.

In some implementations, the digital human can explain and describe the recommended content with reference to a body movement and a facial expression.

In some implementations of this specification, in the above intelligent interaction method, in response to the user accessing the intelligent interaction system, the at least one recommended service is determined based on the user historical data, and the recommended service option is displayed on the interaction page of the user terminal, so that the user can conveniently access the expected service process by using the recommended service option, thereby reducing an interaction process and improving user interaction experience. Then, the intelligent interaction system can make content recommendation based on a combination of the user interaction content and the user historical data that are accessed by the user in real time, which can improve accuracy of content recommendation, and ensure that recommended content more accurately satisfies a user intention, thereby improving user interaction experience. Furthermore, a digital human technology is used to explain and describe the recommended content output by the interaction model, providing the user with an enhanced experience.

In an implementation, in response to the user accessing the intelligent interaction system, an interaction ID corresponding to the current interaction is generated before the interaction page is rendered.

That is, at the beginning of each interaction, an interaction ID corresponding to this interaction is generated, to record an interaction record based on the interaction ID. This allows for easy viewing of historical interaction records or restoration of incomplete historical interaction dialogues.

Further, in an implementation, after step S202 is performed to obtain the user historical data, it is determined, based on the historical interaction data, whether the user has an incomplete historical interaction dialogue; and if it is determined that the user has an incomplete historical interaction dialogue, a corresponding historical interaction record is searched for based on a historical interaction ID corresponding to the historical interaction dialogue, and the historical interaction dialogue is restored based on the historical interaction record and the interaction page is rendered; or if it is determined that the user does not have an incomplete historical interaction dialogue, step S204 is performed.

That is, in some implementations of this specification, after the user accesses the intelligent interaction system, the intelligent interaction system queries whether there is an incomplete historical interaction dialogue based on the historical interaction data; and if there is an incomplete historical interaction dialogue, restores the historical interaction dialogue, queries the corresponding historical interaction record based on the historical interaction ID corresponding to the historical interaction dialogue, and restores the historical interaction dialogue based on the historical interaction record and renders the interaction page, so that the user can continue a subsequent service of the historical interaction dialogue, thereby improving user interaction experience without unnecessary interaction.

In one or more implementations of this specification, the recommended content includes at least one of a recommended interactive text and a recommended interactive component, and the recommended interactive component is configured to provide a corresponding interactive conduct for the user.

In some implementations, the recommended interactive component includes but is not limited to an identity verification component, a penalty component, a reporting component, a limit removal component, a trial component, and a security education component.

Notably, for a service platform having multiple service types, a interaction system is generally separately disposed for each service, and a user needs to perform different types of customer services in different interaction systems. However, the intelligent interaction system provided in some implementations of this specification integrates multiple service products, packaging each service into a corresponding interactive component, such as an identity verification component, a penalty component, a reporting component, a limit removal component, a trial component, or a security education component. Multiple services can be implemented in one intelligent interaction system, eliminating the fragmentation between services. The intelligent interaction system provides users with unified service experience and intelligence, thereby improving user experience.

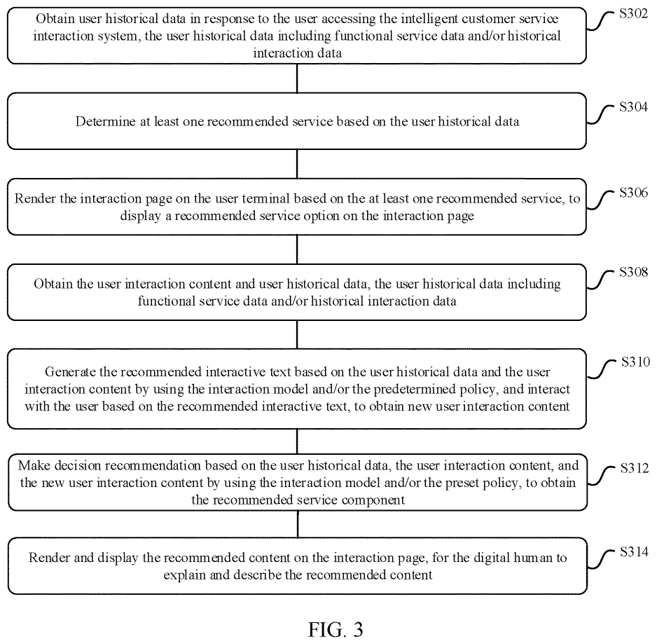

FIG. 3 is a schematic flowchart illustrating an intelligent interaction system according to an implementation of this specification. As shown in FIG. 3, the following steps are included:
S302: Obtain user historical data in response to the user accessing the intelligent interaction system, the user historical data including interactive conduct data and/or historical interaction data;

In some implementations of this specification, after the user accesses the intelligent interaction system, the interaction system obtains a user identifier, and then queries and obtains the user historical data of the user within a latest period of time in a data center based on the user identifier. The user historical data includes the interactive conduct data and the historical interaction data.
S304: Determine at least one recommended service based on the user historical data.

In some implementations of this specification, after obtaining the user historical data, the interaction system determines the at least one recommended service based on the user historical data.
S306: Render the interaction page on the user terminal based on the at least one recommended service, to display a recommended service option on the interaction page.

In some implementations of this specification, after obtaining the user historical data, the interaction system determines the at least one recommended service based on the user historical data. Then, the interaction system displays the determined recommended service on the interaction page as an interaction guide. For example, if a service expected by the user is one of the determined at least one recommended service, the user can directly access a corresponding service process by displaying a recommended service option on the interaction page, thereby reducing an interaction process and improving user experience. If the service expected by the user is not the determined recommended service, the interaction system continues to perform an interaction process in step S208.
S308: Obtain the user interaction content and user historical data, the user historical data including interactive conduct data and/or historical interaction data.
S310: Generate the recommended interactive text based on the user historical data and the user interaction content by using the interaction model and/or the predetermined policy, and interact with the user based on the recommended interactive text, to obtain new user interaction content.

In some implementations of this specification, after accessing the intelligent interaction system, the user can access interaction content on the interaction page in a text or voice input manner. The intelligent interaction system obtains the interaction content accessed by the user and queries and obtains the user historical data of the user within a latest period of time in a data center based on the user identifier, where the user historical data includes the interactive conduct data and the historical interaction data, and then makes decision recommendation based on the user interaction content and the user historical data by using the pre-trained interaction model and/or the predetermined policy, to obtain the recommended interactive text. The recommended interactive text is used for further interactive question answering with the user, so that the interaction model and/or the predetermined policy can better identify a user intention.
S312: Make decision recommendation based on the user historical data, the user interaction content, and the new user interaction content by using the interaction model and/or the predetermined policy, to obtain the recommended interactive component.

After the intelligent interaction system interacts with the user for multiple times, a user intention can be identified based on the user historical data, the user interaction content, and the new user interaction content by using the interaction model and/or the predetermined policy, to recommend a corresponding recommended interactive component for the user, and provide a corresponding service for the user.

The recommended interactive component includes but is not limited to an identity verification component, a penalty component, a reporting component, a limit removal component, a trial component, and a security education component.
S314: Render and display the recommended content on the interaction page, for the digital human to explain and describe the recommended content.

In some implementations of this specification, in the above intelligent method, in response to the user accessing the intelligent interaction system, the at least one recommended service is determined based on the user historical data, and the recommended service option is displayed on the interaction page of the user terminal, so that the user can conveniently access the expected service process by using the recommended service option, thereby reducing an interaction process and improving user interaction experience. Then, the intelligent interaction system can make content recommendation based on a combination of the user interaction content and the user historical data that are accessed by the user in real time, which can improve accuracy of content recommendation, and ensure that recommended content more accurately satisfies a user intention, thereby improving user interaction experience. Furthermore, a digital human technology is used to explain and describe the recommended content output by the interaction model, providing the user with an enhanced experience.

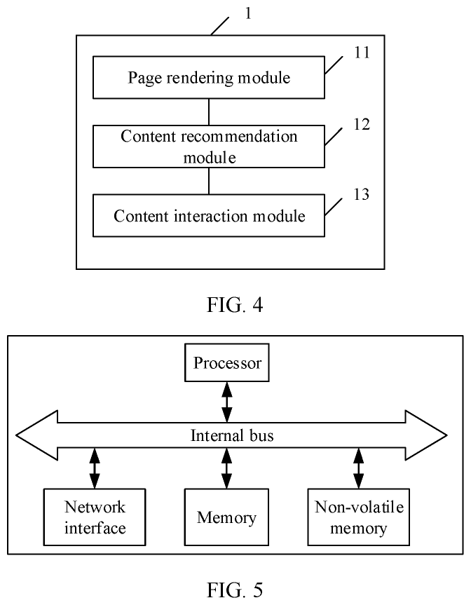

FIG. 4 is a schematic structural diagram illustrating an intelligent interaction system according to an implementation of this specification. As shown in FIG. 4, the intelligent interaction system 1 can be implemented as all or a part of an electronic device by using software, hardware, or a combination thereof. According to some implementations, the intelligent interaction system 1 includes a page rendering module 11, a content recommendation module 12, and a content interaction module 13. Details are as follows:

The page rendering module 11 is configured to render an interaction page on a user terminal in response to a user accessing an intelligent interaction system, the interaction page including a digital human.

The content recommendation module 12 is configured to obtain user interaction content, and make decision recommendation on the user interaction content by using an interaction model and/or a predetermined policy, to obtain recommended content.

The content interaction module 13 is configured to render and display the recommended content on the interaction page, for the digital human to explain and describe the recommended content.

In some implementations, the interaction page includes a recommended service option. The page rendering module 11 is specifically configured to: obtain user historical data in response to the user accessing the intelligent interaction system, the user historical data including interactive conduct data and/or historical interaction data; determine at least one recommended service based on the user historical data; and render the interaction page on the user terminal based on the at least one recommended service, to display the recommended service option on the interaction page.

In some implementations, the page rendering module 11 is further configured to: generate an interaction ID corresponding to the current interaction in response to the user accessing the intelligent interaction system.

In some implementations, the page rendering module 11 is further configured to: determine, based on the historical interaction data, whether the user has an incomplete historical interaction dialogue; and in response to that it is determined that the user has an incomplete historical interaction dialogue, search for a corresponding historical interaction record based on a historical interaction ID corresponding to the historical interaction dialogue, and restore the historical interaction dialogue based on the historical interaction record and render the interaction page; or in response to that it is determined that the user does not have an incomplete historical interaction dialogue, perform the step of determining the at least one recommended service based on the user historical data.

In some implementations, the content recommendation module 12 is specifically configured to: obtain user historical data, the user historical data including interactive conduct data and/or historical interaction data; and make decision recommendation based on the user historical data and the user interaction content by using the interaction model and/or the predetermined policy, to obtain the recommended content.

In some implementations, the recommended content includes at least one of a recommended interactive text and a recommended interactive component, and the recommended interactive component is configured to provide a corresponding interactive conduct for the user.

In some implementations, when making decision recommendation based on the user historical data and the user interaction content by using the interaction model and/or the predetermined policy, to obtain the recommended content, the content recommendation module 12 is specifically configured to: generate the recommended interactive text based on the user historical data and the user interaction content by using the interaction model and/or the predetermined policy, and interact with the user based on the recommended interactive text, to obtain new user interaction content; and make decision recommendation based on the user historical data, the user interaction content, and the new user interaction content by using the interaction model and/or the predetermined policy, to obtain the recommended interactive component.

In some implementations, the recommended interactive component includes but is not limited to an identity verification component, a penalty component, a reporting component, a limit removal component, a trial component, and a security education component.

The above system implementation corresponds to the method implementation. For specific descriptions, reference can be made to the descriptions in the part of the method implementation. Details are omitted herein for simplicity. The system implementation is obtained based on a corresponding method implementation, and has a same technical effect as the corresponding method implementation. For specific descriptions, reference can be made to the corresponding method implementation.

An implementation of this specification further provides a computer storage medium. The computer storage medium can store multiple instructions, and the instructions are suitable for a processor to load and perform the intelligent interaction method in the implementations shown in FIG. 1 to FIG. 3. For a specific execution process, reference can be made to the specific descriptions in the implementations shown in FIG. 1 to FIG. 3. Details are omitted herein for simplicity.

This specification further provides a computer program product. The computer program product stores at least one instruction. The at least one instruction is loaded and executed by the processor in the intelligent interaction method in the implementations shown in FIG. 1 to FIG. 3. For a specific execution process, reference can be made to the specific descriptions in the implementations shown in FIG. 1 to FIG. 3. Details are omitted herein for simplicity.

An implementation of this specification further provides a schematic structural diagram illustrating an electronic device shown in FIG. 5. As shown in FIG. 5, at a hardware level, the electronic device includes a processor, an internal bus, a network interface, a memory, and a non-volatile memory, and certainly can further include hardware required by other services. The processor reads a corresponding computer program from the non-volatile memory and runs the program in the memory, so as to implement the above intelligent interaction method.

Certainly, in addition to a software implementation, this specification does not exclude other implementations, such as a logic device or a combination of software and hardware. In other words, an execution entity of the following processing flow is not limited to each logic unit, but can also be hardware or logic devices.

In the 1990s, whether a technical improvement is a hardware improvement (for example, an improvement to a circuit structure such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application specific integrated circuit chip. In addition, at present, instead of manually manufacturing an integrated circuit chip, this type of programming is mostly implemented by using “logic compiler” software. The software is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using only the computer-readable program code, logic programming can be performed on method steps to enable the controller to implement the same function in forms of the logic gate, the switch, the application-specific integrated circuit, the programmable logic controller, the embedded microcontroller, etc. Therefore, the controller can be considered as a hardware component, and an apparatus included in the controller for implementing various functions can also be considered as a structure in the hardware component. Alternatively, the apparatus configured to implement various functions can even be considered as both a software module implementing the method and a structure in the hardware component.

Systems, apparatuses, modules, or units that are described in the above implementations can be for example implemented by using a computer chip or an entity, or by using a product with a certain function. A typical implementation device is a computer. For example, the computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the above apparatus is described by dividing functions into various units. Certainly, when this specification is implemented, a function of each unit can be implemented in one or more pieces of software and/or hardware.

A person skilled in the art should understand that the implementations of this specification can be provided as methods, systems, or computer program products. Therefore, this specification can use a form of hardware only implementations, software only implementations, or implementations with a combination of software and hardware. Moreover, this specification can use a form of a computer program product that is implemented on one or more computer-usable storage media (including but not limited to a disk memory, a CD-ROM, an optical memory, etc.) that include computer-usable program code.

This specification is described with reference to the flowcharts and/or block diagrams of the methods, the devices (systems), and the computer program products based on the implementations of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

Alternatively, these computer program instructions can be stored in a computer-readable storage that can instruct a computer or another programmable data processing device to work in a specific manner, so the instructions stored in the computer-readable storage generate an artifact that includes an instruction apparatus. The instruction apparatus implements a specific function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, the computer includes one or more processors (CPUs), one or more input/output interfaces, one or more network interfaces, and one or more memories. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively

The memory can include a non-persistent memory, a random access memory (RAM), a non-volatile memory, and/or another form that are in a computer-readable medium, for example, a read-only memory (ROM) or a flash memory (flash RAM). The memory is an example of the computer-readable medium.

The computer-readable medium includes persistent, non-persistent, removable, and non-removable media that can store information by using any method or technology. The information can be computer-readable instructions, a data structure, a program module, or other data. Examples of a computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a tape and disk storage or another magnetic storage device or any other non-transmission media that can be configured to store information that a computing device can access. As described in this specification, the computer-readable medium does not include transitory computer-readable media (transitory media) such as a modulated data signal and a carrier.

It should also be noted that the terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, an element preceded by “includes a . . . ” does not preclude the existence of additional identical elements in the process, method, product, or device that includes the element.

A person skilled in the art should understand that the implementations of this specification can be provided as a method, a system, or a computer program product. Therefore, this specification can use a form of hardware only implementations, software only implementations, or implementations with a combination of software and hardware. Moreover, this specification can use a form of a computer program product that is implemented on one or more computer-usable storage media (including but not limited to a disk memory, a CD-ROM, an optical memory, etc.) that include computer-usable program code.

This specification can be described in the general context of computer-executable instructions executed by a computer, for example, a program module. Generally, the program module includes a routine, a program, an object, a component, a data structure, etc. executing a specific task or implementing a specific abstract data type. This specification can alternatively be practiced in distributed computing environments in which tasks are performed by remote processing devices that are connected through a communication network. In the distributed computing environments, the program module can be located in local and remote computer storage media including storage devices.

The implementations of this specification are described in a progressive manner. For same or similar parts in implementations, reference can be made to each other. Each implementation focuses on a difference from other implementations. Particularly, the system implementations are basically similar to the method implementations, and therefore are described briefly. For related parts, references can be made to some descriptions of the method implementations.

The above-mentioned descriptions are merely some implementations of this specification, and are not intended to limit this specification. A person skilled in the art can make various variations and changes to this specification. Any modification, equivalent replacement, and improvement made in the spirit and principle of this specification shall fall within the scope of the claims in this specification.

The various embodiments described above can be combined to provide further embodiments. All of the U.S. patents, U.S. patent application publications, U.S. patent applications, foreign patents, foreign patent applications listed in the Application Data Sheet are incorporated herein by reference, in their entirety. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure

1. An intelligent customer service interaction method, comprising:
rendering an interaction page on a user terminal in response to a user accessing an intelligent interaction system, the interaction page including a digital human;
obtaining a user interaction content;
making decision recommendation on the user interaction content by using one or more of an interaction model or a policy, to obtain a recommended content; and
rendering the digital human on the interaction page to illustrate the recommended content.

2. The method according to claim 1, wherein the interaction page includes a recommended service option; and
the rendering the interaction page on the user terminal in response to the user accessing the intelligent interaction system includes:
obtaining user historical data in response to the user accessing the intelligent interaction system, the user historical data including one or more of functional service data or historical interaction data;
determining at least one recommended interaction item based on the user historical data; and
rendering the interaction page on the user terminal based on the at least one recommended interaction item, for the digital human to illustrate the recommended interaction item.

3. The method according to claim 2, further comprising:
generating an interaction ID corresponding to a current interaction in response to the user accessing the intelligent interaction system.

4. The method according to claim 2, further comprising:
after the obtaining the user historical data,
determining, based on the historical interaction data, whether the user has an incomplete historical interaction dialogue; and
in response to that it is determined that the user has an incomplete historical interaction dialogue, searching for a corresponding historical interaction record based on a historical interaction ID corresponding to the historical interaction dialogue, and restoring the historical interaction dialogue based on the historical interaction record and rendering the interaction page; or
in response to that it is determined that the user does not have an incomplete historical interaction dialogue, performing the determining the at least one recommended interaction item based on the user historical data.

5. The method according to claim 1, wherein the making decision recommendation on the user interaction content by using the one or more of the interaction model or the policy, to obtain the recommended content includes:
obtaining user historical data, the user historical data including one or more of functional service data or historical interaction data; and
making decision recommendation based on the user historical data and the user interaction content by using the one or more of the interaction model or the predetermined policy, to obtain the recommended content.

6. The method according to claim 5, wherein the recommended content includes at least one of a recommended interactive text or a recommended interactive component, and the recommended interactive component related to an action of the user.

7. The method according to claim 6, wherein the making decision recommendation based on the user historical data and the user interaction content by using the one or more of the interaction model or the policy, to obtain the recommended content includes:
generating the recommended interactive text based on the user historical data and the user interaction content by using the one or more of the interaction model or the policy, and interacting with the user based on the recommended interactive text, to obtain a new user interaction content; and
making decision recommendation based on the user historical data, the user interaction content, and the new user interaction content by using the one or more of the interaction model or the policy, to obtain the recommended interactive component.

8. The method according to claim 7, wherein the recommended interactive component includes but is not limited to an identity verification component, a penalty component, a reporting component, a limit removal component, a trial component, and a security education component.

9-12. (canceled)

13. A computing system comprising one or more processors and one or more memory devices, the one or more memory devices, individually or collectively, having computer executable instructions stored thereon, the computer executable instructions, when executed by the one or more processors, enabling the one or more processors to, individually or collectively, implement actions including:
rendering an interaction page on a user terminal in response to a user accessing an intelligent interaction system, the interaction page including a digital human;
obtaining a user interaction content;
making decision recommendation on the user interaction content by using one or more of an interaction model or a policy, to obtain a recommended content; and
rendering the digital human on the interaction page to illustrate the recommended content.

14. The system according to claim 13, wherein the interaction page includes a recommended service option; and
the rendering the interaction page on the user terminal in response to the user accessing the intelligent interaction system includes:
obtaining user historical data in response to the user accessing the intelligent interaction system, the user historical data including one or more of functional service data or historical interaction data;
determining at least one recommended interaction item based on the user historical data; and
rendering the interaction page on the user terminal based on the at least one recommended interaction item, for the digital human to illustrate the recommended interaction item.

15. The method according to claim 14, wherein the actions further include:
generating an interaction ID corresponding to a current interaction in response to the user accessing the intelligent interaction system.

16. The system according to claim 14, wherein the actions further include:
after the obtaining the user historical data,
determining, based on the historical interaction data, whether the user has an incomplete historical interaction dialogue; and
in response to that it is determined that the user has an incomplete historical interaction dialogue, searching for a corresponding historical interaction record based on a historical interaction ID corresponding to the historical interaction dialogue, and restoring the historical interaction dialogue based on the historical interaction record and rendering the interaction page; or
in response to that it is determined that the user does not have an incomplete historical interaction dialogue, performing the determining the at least one recommended interaction item based on the user historical data.

17. The system according to claim 13, wherein the making decision recommendation on the user interaction content by using the one or more of the interaction model or the policy, to obtain the recommended content includes:
obtaining user historical data, the user historical data including one or more of functional service data or historical interaction data; and
making decision recommendation based on the user historical data and the user interaction content by using the one or more of the interaction model or the predetermined policy, to obtain the recommended content.

18. The system according to claim 17, wherein the recommended content includes at least one of a recommended interactive text or a recommended interactive component, and the recommended interactive component is related to an action of the user.

19. The system according to claim 18, wherein the making decision recommendation based on the user historical data and the user interaction content by using the one or more of the interaction model or the policy, to obtain the recommended content includes:
generating the recommended interactive text based on the user historical data and the user interaction content by using the one or more of the interaction model or the policy, and interacting with the user based on the recommended interactive text, to obtain a new user interaction content; and
making decision recommendation based on the user historical data, the user interaction content, and the new user interaction content by using the one or more of the interaction model or the policy, to obtain the recommended interactive component.

20. The system according to claim 19, wherein the recommended interactive component includes but is not limited to an identity verification component, a penalty component, a reporting component, a limit removal component, a trial component, and a security education component.

21. A computer readable storage medium having computer executable instructions stored thereon, the computer executable instructions, when executed by one or more processors, enabling the one or more processors to, individually or collectively, implement actions including:
rendering an interaction page on a user terminal in response to a user accessing an intelligent interaction system, the interaction page including a digital human;
obtaining a user interaction content;
making decision recommendation on the user interaction content by using one or more of an interaction model or a policy, to obtain a recommended content; and
rendering the digital human on the interaction page to illustrate the recommended content.

22. The storage medium according to claim 21, wherein the interaction page includes a recommended service option; and
the rendering the interaction page on the user terminal in response to the user accessing the intelligent interaction system includes:
obtaining user historical data in response to the user accessing the intelligent interaction system, the user historical data including one or more of functional service data or historical interaction data;
determining at least one recommended interaction item based on the user historical data; and
rendering the interaction page on the user terminal based on the at least one recommended interaction item, for the digital human to illustrate the recommended interaction item.

23. The storage medium according to claim 22, wherein the actions further include:
generating an interaction ID corresponding to a current interaction in response to the user accessing the intelligent interaction system.

24. The storage medium according to claim 22, wherein the actions further include:
after the obtaining the user historical data,
determining, based on the historical interaction data, whether the user has an incomplete historical interaction dialogue; and
in response to that it is determined that the user has an incomplete historical interaction dialogue, searching for a corresponding historical interaction record based on a historical interaction ID corresponding to the historical interaction dialogue, and restoring the historical interaction dialogue based on the historical interaction record and rendering the interaction page; or
in response to that it is determined that the user does not have an incomplete historical interaction dialogue, performing the determining the at least one recommended interaction item based on the user historical data.
